(19) United States
(12) Patent Application Publication
(10) Pub. No.: US 2008/0134315 A1
(43) Pub. Date: Jun. 5, 2008

(54) Gateway, Network Configuration, And Method For Conrtolling Access To Web Server

(75) Inventors: Tomofumi Tamura, Kanagawa (JP); Yuji Hashimoto, Kanagawa (JP); Yuzo Moriuchi, Kanagawa (JP); Satoshi Iino, Kanagawa (JP); Kenichiro Iida, Kanagawa (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., OSAKA (JP)

(21) Appl. No.: 11/722,161

(22) PCT Filed: Dec. 20, 2005
(86) PCT No.: PCT/JP05/23314

§ 371 Date: Jun. 19, 2007

(30) Foreign Application Priority Data
Dec. 21, 2004 (JP) 2004-369693

(51) Int. Cl. G06F 17/00

(52) U.S. Cl. 726/12

(57) ABSTRACT

It is possible to realize an easy access control not requiring complicated setting of user access authority in each Web server or not requiring user authentication each time each Web server is accessed. A dedicated DNS server (52) for managing a domain name is arranged in a dedicated network (50). When a gateway (40) is an authenticated terminal according to the authentication by an authentication server (53) in the dedicated network (50), the IP address of the dedicated server (52) is set as the DNS server address. When the gateway (40) is an authentication-disabled terminal, the IP address of the DNS server (32) is set as the DNS server address. Thus, the DNS solution of the authenticated terminal (12) is performed by the dedicated DNS server (52).

### TECHNICAL FIELD

The present invention relates to a gateway suitably used to control access from, for example, a terminal having a Web browser to a Web server, a network system and a method of controlling access to the server.

### BACKGROUND ART

Conventionally, accessing a dedicated Web server which includes charged sites and dedicated sites from a private network constructed in a home via a gateway requires access control such that access is restricted according to a user's right to access or the like.

Currently, a method of providing an account for each user, setting a right for each account and controlling access according to the right constitutes a mainstream of control over access to a Web server (e.g., see Patent Document 1). Such access control is realized by providing an application program in the Web server with a function to perform access control according to the user right.

Here, an example of conventional access control of Web server will be explained with reference to FIG. 1. In this figure, suppose a case where a terminal (for example, a personal computer provided with a Web browser) 12 which becomes a Web client accesses dedicated Web server 21-1 or 21-2 which maintains dedicated sites. Terminal 12 in private network 10 is connected to IP (Internet Protocol) public network 30 through gateway 11 and dedicated Web servers 21-1 and 21-2 in dedicated network 20 are connected to IP public network 30 through gateway 22.

When terminal 12 of private network 10 accesses dedicated Web server 21-1 or 21-2, the user inputs the domain name of dedicated Web server 21-1 or 21-2 to the Web browser of terminal 12 first. That is, when accessing a Web server on the Internet, it is necessary to specify the IP address of the Web server and then access it, but since the IP address is a string of numbers which is difficult for people to understand, a domain name is generally used which is easy for people to understand. The domain name is associated with the IP address of the server device and managed by a DNS (Domain Name System) server 32.

When the user inputs a domain name to the Web browser of terminal 12, the Web browser inquires of DNS server (IP address: yyy.yyy.yyy.aaa) 32 set in terminal 12 beforehand about the IP address which corresponds to the domain name (hereinafter, this will be referred to as “DNS resolution”) . DNS server 32 which has received the DNS resolution searches the corresponding IP address through recursive search and sends back the IP address (suppose, for example, xxx.xxx.xxx.2) to the Web browser of terminal 12 which is the access source. The Web browser of terminal 12 which has received the IP address sends out a display request of a Web page to the server device (dedicated Web server 21-1 in this case) at IP address (xxx.xxx.xxx.2).

Dedicated Web server 21-1 which has received the display request reports to terminal 12 that authentication is required. More specifically, dedicated Web server 21-1 shows a display prompting input of a user identification number (user ID) and a password on the Web browser of terminal 12. When the user inputs the user ID and password, the information input is sent to dedicated Web server 21-1. In dedicated Web server 21-1, access right is set in association with the user ID and the password and dedicated Web server 21-1 judges whether user ID and the password sent from terminal 12 have an access right or not and thereby judges whether or not to authorize the access. Dedicated Web server 21-1 transmits the content to terminal 12 only when the user is authorized to access dedicated Web server 21-1 is authorized and causes the Web browser of terminal 12 to display the content.
Patent Document 1: Japanese Patent Application Laid-Open No. HEI 11-161602

### DISCLOSURE OF INVENTION

### Problems to be Solved by the Invention

However, according to the conventional method of controlling access to a Web server, an access right of a user is set for each Web server, and therefore such a setting is complicated. Furthermore, for every access to the Web server, the Web server authenticates the user and judges whether or not to authorize access to the Web server, which involves a problem that access control becomes complicated.

It is an object of the present invention to provide a gateway, network system and method of controlling access to a server capable of realizing easy access control without requiring any complicated setting of user access right to each server (e.g., Web server) or the like and without requiring user authentication for every access to each server (e.g., Web server).

### Means for Solving the Problem

When a dedicated DNS server for managing domain names in a private network is arranged and a gateway arranged between the dedicated DNS server and a terminal sets an IP address in the terminal, depending on whether the terminal is authenticated or not by an authentication server, the gateway sets an address of the dedicated DNS server only in the authenticated terminal and in this way the dedicated DNS server performs a DNS resolution on the authenticated terminal.

### Advantageous Effect of the Invention

According to the present invention, only a terminal authenticated by the authentication server can access the dedicated server by reporting the dedicated DNS server address depending on whether the terminal is authenticated or not. As a result, it is possible to realize control of access to the server (e.g., Web server) without requiring any complicated setting of user access right or the like for each server (e.g., Web server).

### BRIEF DESCRIPTION OF DRAWINGS

FIG. 1 is a block diagram showing a conventional network configuration;

FIG. 2 is a block diagram showing a network configuration according to Embodiment 1 of the present invention;

FIG. 3A shows examples of domain names and IP addresses managed by a dedicated DNS server and FIG. 3B shows examples of domain names and IP addresses managed by a DNS server;

FIG. 4 is a block diagram showing a schematic configuration of the gateway on the private network side in FIG. 2;

FIG. 5 is a sequence diagram to explain a method of setting a DNS server address for a terminal in the gateway on the private network side in FIG. 2;

FIG. 6 shows an example of a terminal management table managed at the terminal management section of the gateway on the private network side in FIG. 2;

FIG. 7 shows an example of the format of a DHCP message broadcast when the terminal in FIG. 2 acquires an IP address;

FIG. 8 is a flow chart to explain address setting processing executed at the address setting section of the gateway on the private network side in FIG. 2;

FIG. 9 is a block diagram showing a network configuration according to Embodiment 2 of the present invention; and

FIG. 10A shows examples of domain names and IP addresses managed by a dedicated DNS server and FIG. 10B shows examples of domain names and IP addresses managed by a DNS server.

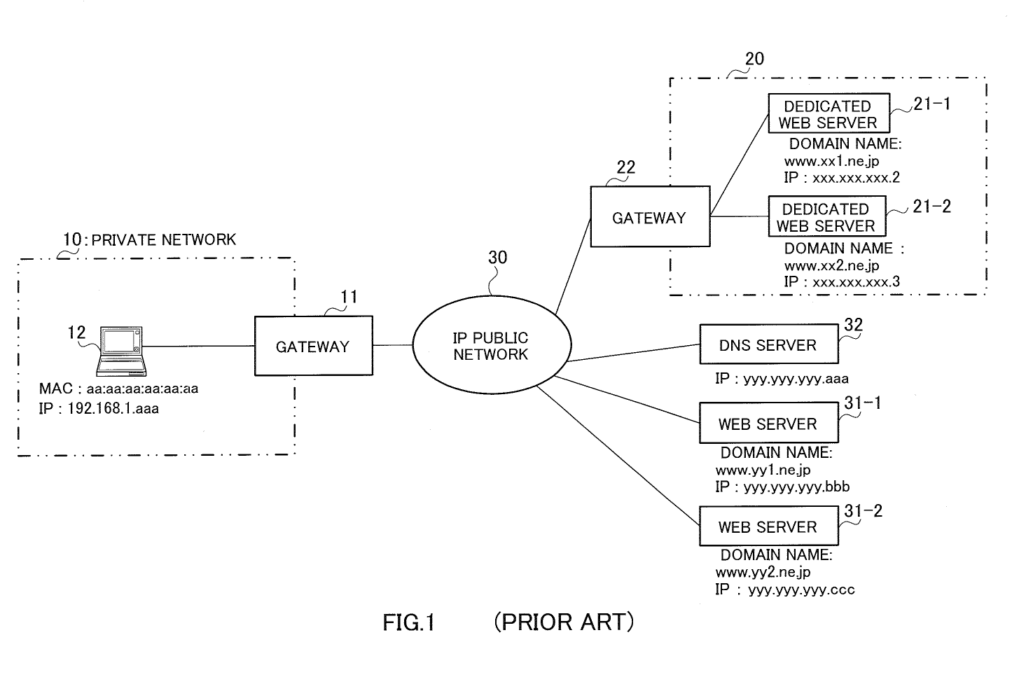

### BEST MODE FOR CARRYING OUT THE INVENTION

Hereinafter, embodiments of the present invention will be explained in detail with reference to the attached drawings.

### Embodiment 1

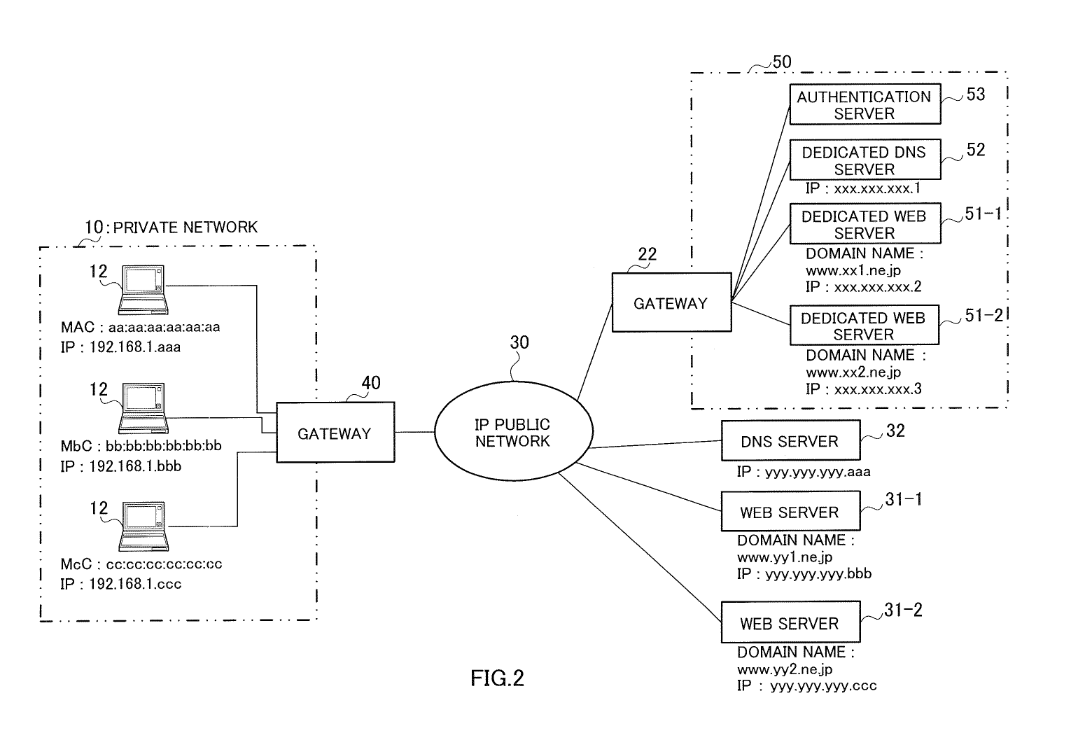

FIG. 2 is a block diagram showing the network configuration according to Embodiment 1 of the present invention. In this figure, the network configuration of this embodiment includes private network 10, IP public network 30 and dedicated network 50. Private network 10 is provided with gateway 40 and a plurality of terminals 12 that become Web clients. Dedicated network 50 is provided with dedicated Web servers 51-1 and 51-2 that maintain charged sites or dedicated sites, dedicated DNS server 52 that manages domain names of dedicated Web servers 51-1 and 51-2, authentication server 53 that authenticates terminals 12 and gateway 22. Web servers 31-1 and 31-2 and DNS server 32 that manages their domain names exist in IP public network 30.

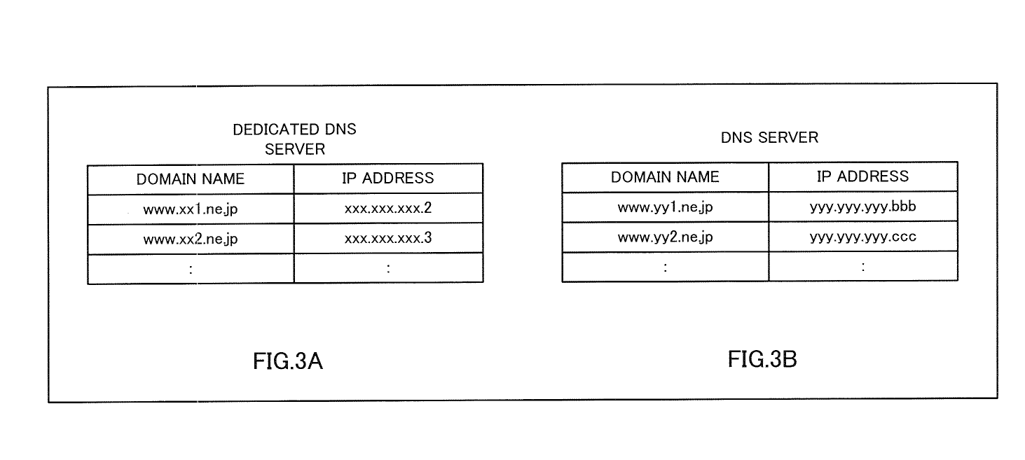

As shown in FIG. 3B, DNS server 32 manages domain names of Web servers 31-1 and 31-2 in association with their IP addresses. As shown in FIG. 3A, dedicated DNS server 52 also manages domain names of dedicated Web servers 51-1 and 51-2 in association with their IP addresses.

During a DNS resolution from each terminal 12, inquiries about IP addresses from DNS server 32 in IP public network 30 to dedicated DNS server 52 in dedicated network 50 are prohibited. For terminal 12 authenticated by authentication server 53 in dedicated network 50, dedicated DNS server 52 is set as a DNS server and for terminal 12 not authenticated, DNS server 32 in public network 30 is set as a DNS server.

A method of setting a DNS server address for terminal 12 based on the status of authentication will be explained below.

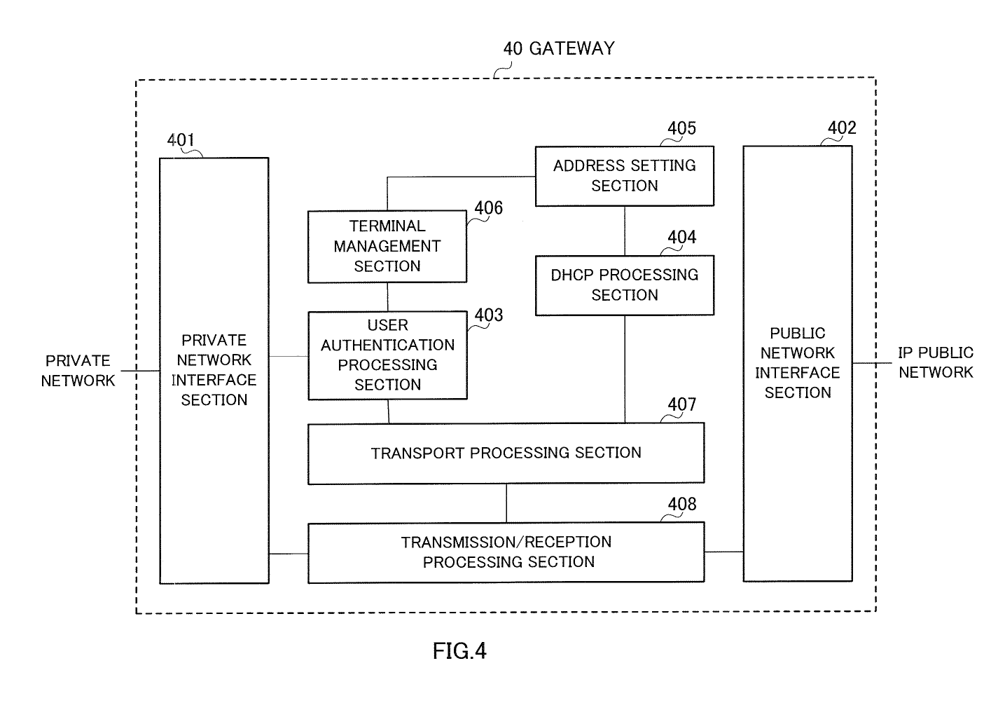

FIG. 4 is a functional block diagram of gateway 40. In this figure, gateway 40 is configured by including private network interface section 401, public network interface section 402, user authentication processing section 403, DHCP (Dynamic Host Configuration Protocol) processing section 404, address setting section 405, terminal management section 406, transport processing section 407 which processes transport layer protocols such as TCP (Transmission Control Protocol) and UDP (User Datagram Protocol) and transmission/reception processing section 408 that carries out transmission/reception processing.

User authentication processing section 403 processes an authentication frame from the user used in IEEE.802.1x authentication and an authentication frame from authentication server 53. Furthermore, user authentication processing section 403 also maintains information as to whether terminal 12 succeeded or failed in the authentication for each terminal 12 and reports this information to terminal management section 406. According to IEEE802.1x, when a communication is started, authentication is performed between terminal 12 and authentication server 53 using EAP (Extensible Authentication Protocol) prescribed in RFC2284. EAP includes EAP-MD5 whereby authentication is performed using a password only on the user side, EAP-TLS whereby mutual authentication is performed between an authentication server and a client using an electronic certificate and EAP-PEAP/EAP-TTLS whereby mutual authentication is performed using an electronic certificate for the authentication server and ID/password for the client or the like. IEEE802.1x was standardized as a wired LAN specification but it is currently used mainly as a wireless LAN authentication specification.

DHCP processing section 404 processes a DHCP message received from terminal 12 and reports the IP address, subnet mask, DNS server address, effective period of the IP address, default gateway address or the like set at address setting section 405 to terminal 12 using the DHCP message.

Address setting section 405 selects an IP address and a DNS server address to be set in terminal 12 based on the authentication status information of terminal 12 and reports those addresses to DHCP processing section 404. Information on the range of allocatable addresses, subnet mask, address of the DNS server or the like are set in address setting section 405 when the gateway is started.

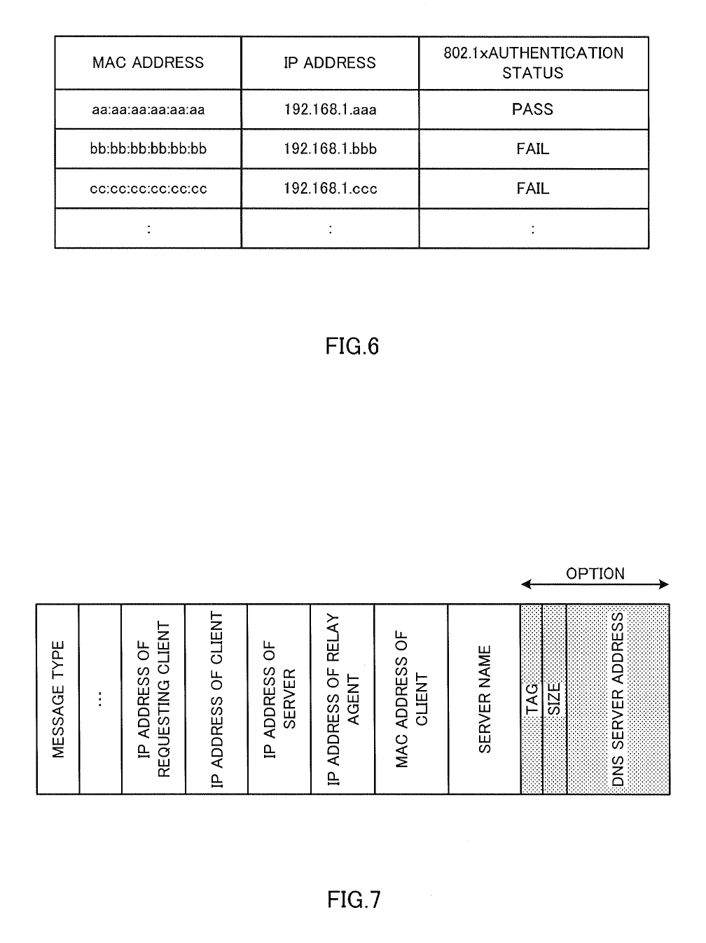

Terminal management section 406 manages the MAC (Media Access Control Address) address of terminal 12, IP address and authentication status information using a terminal management table shown in FIG. 6.

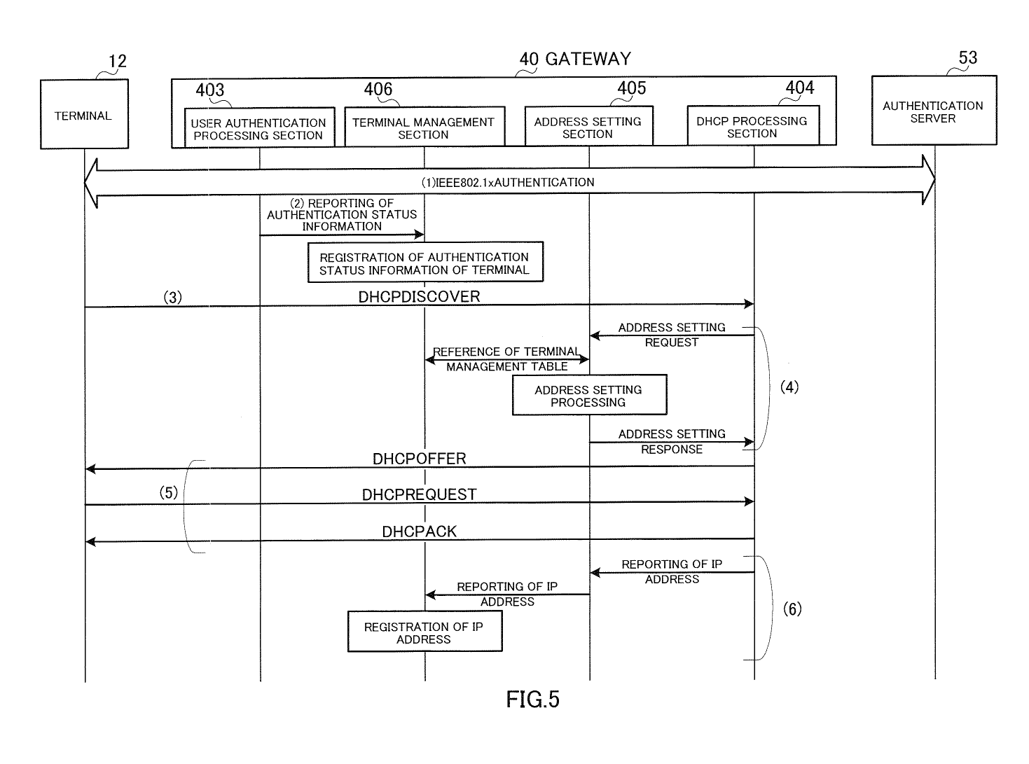

Here, the method of setting the DNS server address of terminal 12 at gateway 40 will be explained using a sequence shown in FIG. 5.

When terminal 12 is connected to gateway 40, authentication processing of IEEE802.1x is performed between terminal 12 and gateway 40 and between gateway 40 and authentication server 53 ((1) in FIG. 5). After the authentication processing, user authentication processing section 403 reports the IEEE802.1x authentication status and MAC address of terminal 12 to terminal management section 406 ((2) in FIG. 5).

Next, terminal management section 406 registers the MAC address and authentication status information in the terminal management table shown in FIG. 6. Terminal 12 then broadcasts a packet (DHCPDISCOVER) to confirm whether or not a DHCP (Dynamic Host Configuration Protocol) server exists on the network in order to acquire an IP address ((3) in FIG. 5).

FIG. 7 shows the format of a DHCP message. DHCPDISCOVER sets 0.0.0.0 as the client IP address, 0.0.0.0 as the server IP address and the MAC address of terminal 12 as the client MAC address. When gateway 40 which is the DHCP server receives a DHCPDISCOVER packet, DHCP processing section 404 extracts MAC address information in the DHCP message and transmits an address setting request including the MAC address as an information element to address setting section 405. Address setting section 405 which has received the address setting request performs address setting processing and reports the set IP address and DNS server address to DHCP processing section 404 in an address setting response ((4) in FIG. 5).

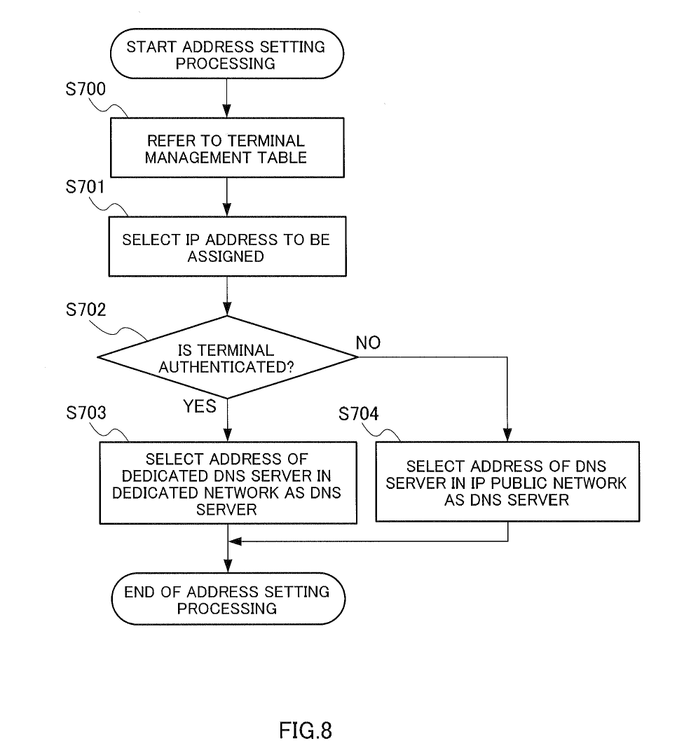

Here, the address setting processing by address setting section 405 will be explained using an address setting processing flow chart in FIG. 8.

Address setting section 405 acquires the authentication status information of the MAC address with reference to the terminal management table at terminal management section 406 (step S700). Address setting section 405 then selects a candidate of the IP address to be assigned to terminal 12 from the range of IP addresses that can be assigned (step S701).

Next, address setting section 405 judges the authentication status of terminal 12 based on the acquired authentication status information (step S702) and when terminal 12 has been authenticated, address setting section 405 selects the IP address of dedicated DNS server 52 in dedicated network 50 as the DNS server address to be set in terminal 12 (step S703) and when terminal 12 has not been authenticated, address setting section 405 selects the IP address of DNS server 32 in IP public network 30 (step S704) ((4) in FIG. 5).

After the above described processing, DHCP processing section 404 sets the candidate of the IP address of the client, the IP address of gateway 40 or the like in DHCPOFFER which is a response message of DHCPDISCOVER based on the address setting response and sets the IP address of the selected DNS server, subnet mask, default gateway address, lease period of the IP address or the like in the option area. Gateway 40 broadcasts DHCPOFFER in which the information is set. The terminal 12 which has received DHCPOFFER broadcasts DHCPREQUEST and requests an IP address. In response to this, gateway 40 checks whether or not other terminal 12 is using the requested IP address and when other terminal 12 is not using the requested IP address, gateway 40 broadcasts DHCPACK ((5) in FIG. 5). When the IP address requested by terminal 12 is already used, gateway 40 broadcasts DHCPNACK.

When terminal 12 receives DHCPACK, terminal 12 sets the IP address specified by DHCPACK, and when receiving DHCPNACK, terminal 12 transmits DHCPDISCOVER once again and acquires an IP address. Upon broadcasting DHCPACK, DHCP processing section 404 reports the IP address set to terminal management section 406 and registers it in the terminal management table ((6) in FIG. 5).

In this way, according to this embodiment, gateway 40 is provided with terminal management section 406 that manages authentication status information indicating whether or not terminal 12 has been authenticated by authentication server 53 and address setting section 405 that selects any one of the address of dedicated DNS server 52 that manages the domain names of dedicated Web servers 51-1, 51-2 which only a terminal authenticated by authentication server 53 is able to access, and the address of DNS server 32 that manages the domain names of Web servers 31-1, 31-2 which terminal 52 that has not been authenticated by authentication server 53 according to authentication status information is able to access and sets it as the DNS server address, and automatically sets a DNS server (32 or 52) to be used by terminal 12 for a DNS resolution according to the authentication status of terminal 12. This allows authenticated terminal 12 to use dedicated DNS server 52 to acquire IP addresses of dedicated Web servers 51-1, 51-2 from the domain names of dedicated Web servers 51-1, 51-2, but unauthenticated terminal 12 does not use dedicated DNS server 52 and therefore cannot acquire the IP addresses of dedicated Web servers 51-1, 51-2 from the domain names of dedicated Web servers 51-1, 51-2. Therefore, unauthenticated terminal 12 cannot access dedicated Web servers 51-1, 51-2 in dedicated network 50.

Thus, it is possible to realize easy access control without requiring any complicated setting of a user access right to dedicated Web servers 51-1, 51-2 or the like and without the necessity for user authentication in dedicated network 50 for every access to dedicated Web servers 51-2, 51-2.

### Embodiment 2

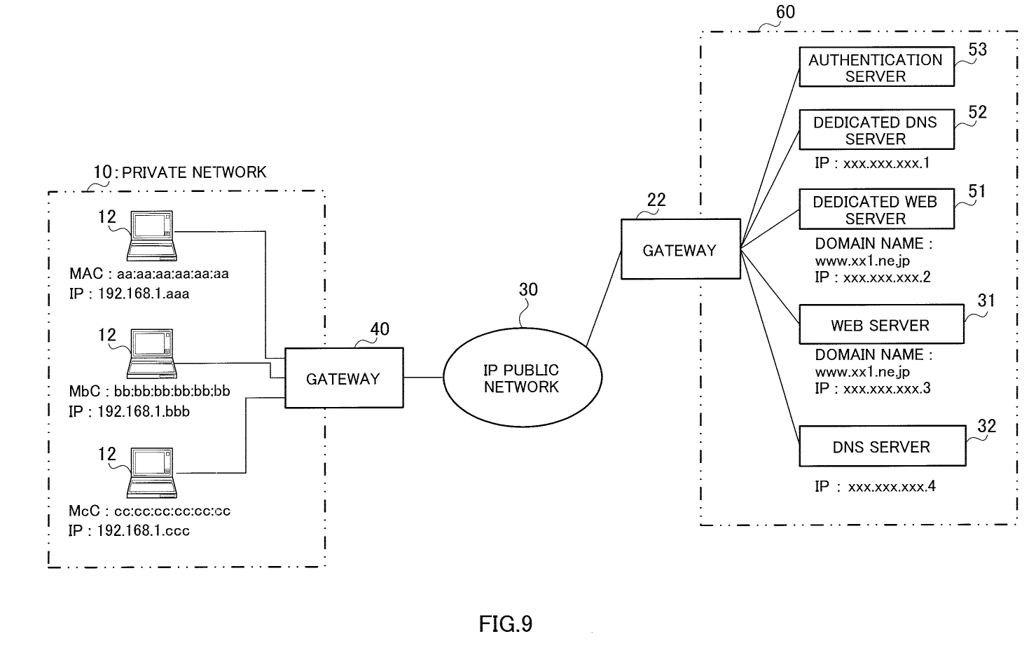

FIG. 9 is a block diagram showing a network configuration according to Embodiment 2 of the present invention. In this figure, parts common to those in above described Embodiment 1 are assigned the same reference numerals. In FIG. 9, private network 10 is made up of gateway 40 and a plurality of terminals 12. Dedicated network 60 is configured by dedicated Web server 51 only authenticated users are able to access, dedicated DNS server 52 that manages the domain name of dedicated Web server 51, Web server 31 unauthenticated users are able to access, DNS server 32 that manages the domain name of Web server 31 thereof, authentication server 53 and gateway 22.

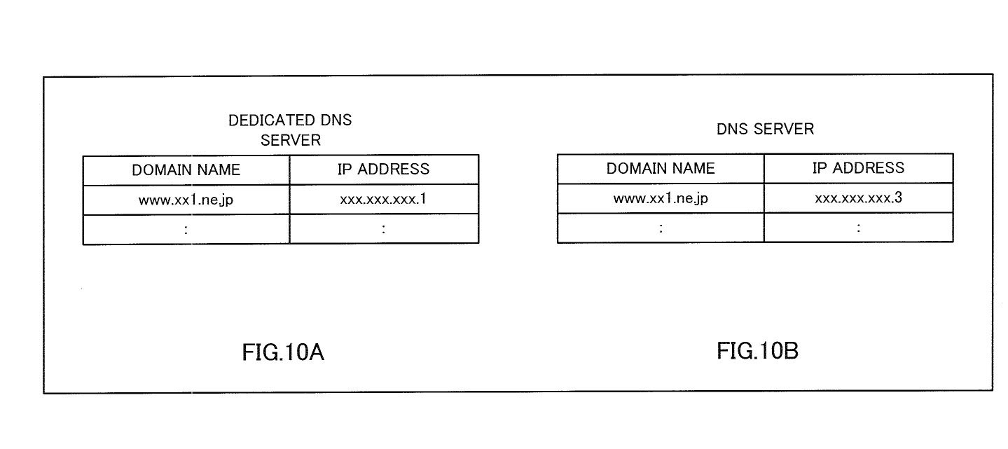

As shown in FIG. 10A, dedicated DNS server 52 manages the domain name of dedicated Web server 51 in association with an IP address thereof and as shown in FIG. 10B, DNS server 32 manages the domain name of Web server 31 in association with an IP address thereof.

In this embodiment, during a DNS resolution from terminal 12, inquiries about the IP address from DNS server 32 to dedicated DNS server 52 are prohibited. For terminal 12 authenticated by authentication server 53, dedicated DNS server 52 is set as the DNS server, whereas for unauthenticated terminal 12, DNS server 32 is set as the DNS server. The DNS server address is set based on an authentication status using DHCP as in the case of above described Embodiment 1. Furthermore, the functional block diagram of gateway 40 is also the same as that in Embodiment 1. DNS server 32 and Web server 31 in this embodiment may also be arranged in IP public network 30 outside dedicated network 60 as in the case of Embodiment 1.

According to this embodiment in this way, unauthenticated terminal 12 cannot access dedicated Web server 51 as in the case of above described Embodiment 1. Furthermore, when different IP addresses are registered in DNS server 32 and dedicated DNS server 52 under the same domain name, in a case where authenticated or unauthenticated terminal 12 accesses under the same domain name, viewing of a content may be allowed according to the authentication status of terminal 12, which is suitable. In this case, it naturally goes without saying that the contents are different when authenticated and when not authenticated. This allows contents of different qualities to be viewed under one domain name according to the authentication status of the terminal.

In the above described embodiments, dedicated DNS server 52 is arranged in dedicated networks 50, 60, but since it is only necessary to manage the domain names of dedicated Web servers 51-1, 51-2 and 51, dedicated DNS server 52 need not always be arranged in dedicated networks 50, 60 and dedicated DNS server 52 maybe arranged, for example, in IP public network 30.

Furthermore, the above described embodiments have the case where layer 2 authentication is performed as an example, but authentication of terminal 12 needs only to be performed before an automatic address setting by DHCP, and therefore layer 2 authentication is not always required.

Furthermore, the above described embodiments have explained the Web server as an example of the server accessed after a DNS resolution is realized, but the server is not always limited to the Web server if it is at least a server accessed after a DNS resolution is realized.

Furthermore, the above described embodiments have explained the case where one dedicated DNS server 52 and one DNS server 32 are provided, but the present invention is also applicable to a case where two or more dedicated DNS servers and DNS servers are provided respectively.

One aspect of the gateway of the present invention adopts a configuration having: a terminal management section that manages authentication status information indicating whether or not a terminal is authenticated by an authentication server; and an address setting section that selects one of an address of a dedicated domain name system server, the dedicated domain name system server managing a domain name of a dedicated server only a terminal authenticated by the authentication server is allowed to access, and an address of a domain name system server, the domain name system server managing a domain name of a server a terminal not authenticated by the authentication server is allowed to access, according to the authentication status information, and sets the selected address as the domain name system server address for the terminal.

Another aspect of the gateway of the present invention adopts a configuration in which the address setting section sets the address of the dedicated domain name system server for the terminal authenticated by the authentication server and sets the address of the domain name system server for the terminal not authenticated by the authentication server on the other.

An aspect of the network system of the present invention adopts a configuration having: a dedicated domain name system server that is provided in a dedicated network where a dedicated server having a pay site or a dedicated site exists and that manages a domain name of a dedicated server provided in the dedicated network; an authentication server that performs authentication of a terminal upon access to the dedicated server; and a gateway that is provided between the dedicated network and the terminal and that sets the address of the dedicated domain name system server only for a terminal authenticated by the authentication server as a domain name system server address of the terminal.

An aspect of the method of controlling access to a server of the present invention includes: a step by an authentication server of authenticating access to a dedicated server of a terminal; a step of setting an address of a dedicated domain name system server that manages a domain name of the dedicated server for only an authenticated terminal as a domain name system server address of the terminal; and a step by a terminal that accesses the dedicated domain name system server of acquiring an address for accessing the dedicated server from the dedicated domain name system server and accessing the dedicated server.

According to these configurations and method, the dedicated DNS server or DNS server is selectively set as the DNS server address of the terminal according to an authentication status of the terminal, and therefore only the terminal authenticated by the authentication server can obtain an IP address to access the dedicated server in the dedicated network through the dedicated DNS server and access the dedicated server. As a result, it is no longer necessary to make any complicated setting such as a user access right for each dedicated server and it is possible to realize easy access control. In addition, the IP address to access the dedicated server is obtained through the dedicated DNS server, and therefore it is possible to realize easy access control without the need for user authentication for every access to each dedicated server.

The present application is based on Japanese Patent Application No. 2004-369693 filed on Dec. 21, 2004, the entire content of which is expressly incorporated by reference herein.

### INDUSTRIAL APPLICABILITY

The present invention is suitably used to control access to a Web server from a terminal having a Web browser.

1-5. (canceled)

6. A gateway comprising:
a terminal management section that manages authentication status information indicating whether or not a terminal is authenticated by an authentication server; and
an address setting section that selects one of an address of a dedicated domain name system server, said dedicated domain name system server managing a domain name of a dedicated server only a terminal authenticated by the authentication server is allowed to access, and an address of a domain name system server, said domain name system server managing a domain name of a server a terminal not authenticated by the authentication server is allowed to access, according to the authentication status information, and sets the selected address as the domain name system server address for the terminal.

7. The gateway according to claim 6, wherein the address setting section sets the address of the dedicated domain name system server for the terminal authenticated by the authentication server and sets the address of the domain name system server for the terminal not authenticated by the authentication server.

8. A network system comprising:
a dedicated domain name system server that is provided in a dedicated network where a dedicated server having a pay site or a dedicated site exists and that manages a domain name of a dedicated server provided in the dedicated network;
a general domain name system server that manages domain names of servers other than the dedicated server;
an authentication server that performs authentication of a terminal upon access to the dedicated server; and
a gateway that is provided between the dedicated network and the terminal, selects one of an address of the dedicated domain name system server, said dedicated domain name system server managing a domain name of a dedicated domain name system server only a terminal authenticated by the authentication server is allowed to access, and an address of the general domain name domain name of a server a terminal not authenticated by the authentication server is able to access, according to the authentication status information, and sets the selected address as the domain name system server address for the terminal.

9. The network system according to claim 8, wherein different internet protocol addresses are registered under the same domain name in the dedicated domain name system server and the domain name system server, to allow different contents to be viewed according to an authentication status of the terminal.

10. A method of controlling access to a server, comprising the steps of:
authenticating access of a terminal to a dedicated server by an authentication server;
managing an address of a dedicated domain name system server that manages a domain name of the dedicated server and an address of a general domain name system server that manages domain names of servers other than the dedicated server, and setting the address of the dedicated domain name system server for an authenticated terminal and the address of the general domain name system server address for the terminals; and
at the terminal for which the address of the dedicated domain name system server is set as the domain name system server address, acquiring an address for accessing the dedicated server from the dedicated domain name system server and accessing the dedicated server, and, at the terminal for which the address of the general domain name system server is set as the domain name system server address, acquiring an address for accessing a server other than the dedicated server from the general domain name system server and accessing the server.
